(19) United States
(12) Patent Application Publication
(10) Pub. No.: US 2026/0073304 A1
(43) Pub. Date: Mar. 12, 2026

(54) CONTINUOUS MODEL ACCURACY INFORMATION CONSUMPTION DURING AN ANALYTICS TRANSFER

(71) Applicant: HUAWEI TECHNOLOGIES CO., LTD., Shenzhen (CN)

(72) Inventors: Clarissa Marquezan, Munich (DE); Haiyang Sun, Beijing (CN)

(73) Assignee: HUAWEI TECHNOLOGIES CO., LTD., Shenzhen (CN)

(21) Appl. No.: 19/387,220

(22) Filed: Nov. 12, 2025

Related U.S. Application Data
(63) Continuation of application No. PCT/CN2023/107854, filed on Jul. 18, 2023.

(51) Int. Cl. G06N 20/00; G06F 18/21; H04W 24/10; H04W 60/06

(52) U.S. Cl. CPC G06N 20/00; G06F 18/217; H04W 24/10; H04W 60/06

(57) ABSTRACT

Model accuracy information for a model, which is associated with a model identifier (ID) and/or an analytics ID, is provided and consumed in a mobile communication network having a plurality of network entities. The model may be used for generating and/or providing analytics information for the analytics ID. Continuous consumption of the model accuracy information is enabled, even in the case of an analytics transfer, including, for instance, a transfer of the analytics ID from one network entity to another. The network entities are configured to respectively provide and receive indications to change a provisioning of model accuracy information and indications related to a change of the provisioning of model accuracy information.

### CROSS-REFERENCE TO RELATED APPLICATIONS

This application is a continuation of International Application No. PCT/CN2023/107854, filed on Jul. 18, 2023, the disclosure of which is hereby incorporated by reference in its entirety.

### TECHNICAL FIELD

The present disclosure relates to a new generation communication network, for instance, to a 5^{th} generation (5G) or 6^{th} generation (6G) mobile network. The disclosure is concerned with providing and consuming model accuracy information for a model, which is associated with a model identifier (ID) and/or an analytics identifier (ID), for example, a model used for generating and/or providing analytics information for the analytics ID. The disclosure is particularly concerned with enabling a continuous consumption of the model accuracy information, even in the case of an analytics transfer, for instance, a transfer of the analytics ID from one network entity to the other. To this end, his disclosure proposes various network entities and corresponding methods.

### BACKGROUND

As per the 3^{rd} generation partnership project (3GPP) Release 17 (R17) definitions in TS 23.288, an analytics ID can be transfer from a first network entity to a second network entity in different situations. In particular, it can be transferred from a source network data analytics function (NWDAF) to a target NWDAF. For instance, if the source NWDAF has to shut down and needs to relocate one or more subscriptions to the target NWDAF, a subscription for analytics may continue to be calculated and provided in the target NWDAF. The benefit of such an analytics transfer procedure is to enable continuity of the service(s) provided by the NWDAF to the consumer of the service. In R17, according to the definitions in TS 23.288, the service provided by the NWDAF is the analytics output generation.

Advances in the 3GPP study item on enablers for automation TR 23.700-81 for Release 18 (R18) and advances in the specification of R18 in TS 23.288 have enhanced NWDAF services—particularly have enhances NWDAFs containing an Analytics Logical Function (AnLF)—with two important new characteristics and services: (a) The NWDAF with AnLF can check and provide the accuracy of an analytics ID that is consumed by a network function (NF); and (b) the NWDAF with AnLF can check and provide the accuracy of an analytics ID associated with a machine learning (ML) model to an NWDAF containing a Model Training Logical Function (MTLF). The NWDAF with MTLF is configured to provide the ML model to the NWDAF with AnLF.

Notably, there is a difference between generating analytics accuracy information for an analytics ID and generating accuracy information for an ML model. In the first case, the NWDAF may use collected information related to the subscribed analytics ID, in order to generate the analytics ID, considering different ML models used for the same analytics ID. Alternatively it can use collected information related to the subscribed analytics ID and a given ML model associated with the analytics ID. In the second case, i.e., when generating the ML model accuracy information, the NWDAF with AnLF may use the information of different subscriptions for the analytics ID using the same ML model, in order to calculate accuracy information for the ML model. These are two different processes, which involve two different types of consumers, different sets of data (which could overlap or not) to be used for the calculation, and finally two different types of information provided for the different consumers.

The NWDAF with MTLF is neither involved in, nor is it aware of, any analytics transfer procedure. With the current standard specifications, the target NWDAF receives the information about the NWDAF with MTLF that provides the model. If the ML model ID for the transferred analytics ID is already stored at target NWDAF, the target NWDAF has no reason to interact with the NWDAF with MTLF providing the ML model.

### SUMMARY

The present disclosure and its solutions are further based on the following considerations.

The current standard specifications do not address what happens with model accuracy information for the ML model, which is provided by the source NWDAF with AnLF to the NWDAF with MTLF, when the analytics ID associated with the ML model is transferred to the target NWDAF with AnLF.

This disclosure assumes a scenario, where the NWDAF with MTLF subscribes to an NWDAF with AnLF to obtain the ML model accuracy information. As per TS 23.288 V18.1.0, the NWDAF with MTLF can determine that it needs to subscribe for accuracy information for a ML model, upon receiving a registration from the NWDAF with AnLF, wherein the registration indicates that such NWDAF intends to monitor the accuracy information for an analytics ID using a given ML Model and local policies. The NWDAF with MTLF then subscribes to the NWDAF with AnLF to retrieve the model accuracy information for the ML model. In the subscription, the NWDAF with MTLF includes the unique identifier(s) of the ML model(s) to be monitored, accuracy metrics to be monitored, and optionally reporting threshold(s) or reporting period.

The NWDAF with MTLF is further able to determine, based on the ML model accuracy information received from NWDAF with AnLF, the need to retrain the ML model and/or to reselect different ML models to be used for the analytics ID.

As defined in Clause 6.2E.3.2 in TS 23.288, the NWDAF with AnLF can be triggered to register in the NWDAF with MTLF (therefore triggering such NWDAF with MTLF to subscribe to the ML model accuracy information) based on local policies or a request from a service consumer (i.e., and NF consumer of analytics output requiring also the generation of accuracy information for the analytics ID as defined in Clause 6.2D).

In the considered scenario, the transfer of the analytics ID will not cause the target NWDAF with AnLF to start providing the analytics accuracy information, because the subscription to the analytics ID did not require the generation of the analytics accuracy information. This will also prevent the target NWDAF to register at the NWDAF with MTLF as a provider of the model accuracy information for the ML model that is transferred with the analytics ID. As a consequence, of this, the following issues may arise:
The usage of the model accuracy information, in order to determine the appropriated action to re-train or reselect one or more ML models, can be affected by misconfigurations in different NWDAFs, since the (new) target NWDAF may not have the same configuration as the source NWDAF during/after an analytics transfer. Any gap between considering and not considering model accuracy information from different NWDAFs may lead to instability in the overall determination of actions taken by the NWDAF with MTLF.
A high overhead and an unnecessary signaling of the source NWDAF with AnLF, in order to deregister from the NWDAF with MTLF, may occur. This consequently leads to the NWDAF with MTLF unnecessarily tearing down subscriptions to the model accuracy information (as per Clause 6.2E.3). Further, in parallel, the new target NWDAF with AnLF triggers a registration at the NWDAF with MTLF and later a subscription to the ML model accuracy information.

In view of these issues, the present disclosure aims to provide an improved solution for the analytics transfer, particularly, in view of the provisioning and consumption of model accuracy information. An objective is to prevent a network entity that consumes the model accuracy information (e.g., the NWDAF with MTLF in the above scenario) to perform unnecessary signaling and/or to determine inaccurate ML model (degradation) information. Another objective is to avoid inaccurate triggering of (an unnecessary) reselection of a ML model, or an inaccurate decision to not retrain and/or reselect a ML model related to an analytics ID, which is transferred among a source and target network entity (e.g., the source and target NWDAFs with AnLF in the above scenario).

A first aspect of this disclosure provides a first network entity for generating model accuracy information for a model associated with a model identifier and/or an analytics identifier, ID, the first network entity being configured to: obtain a first indication to change a provisioning of model accuracy information, wherein the provisioning of model accuracy information is consumed by a third network entity for consuming model accuracy information for the model and is associated with the model and one or more parameter information, and wherein the model accuracy information denotes a quality information about the model; and provide a second indication related to a change of the provisioning of model accuracy information to the third network entity based on the first indication, wherein the second indication comprises at least one of the following: a first information indicating a termination of the provisioning of model accuracy information for the model and/or the analytics ID at the first network entity; a second information indicating a relocation of the provisioning of model accuracy information for the model and/or analytics ID from the first network entity to a second network entity; a third information indicating one or more changes related to the provisioning of model accuracy information for the model and/or analytics ID; a fourth information indicating a registration of the second network entity as a provider of model accuracy information for the model and/or analytics ID in accordance with the first indication.

The first information is also referred to as “ML Model Accuracy Provisioning Termination” in this disclosure. The second information is also referred to as “ML Model Accuracy Provisioning Relocation” in this disclosure.

The first network entity may be a source NWDAF with AnLF, while the second network entity may be a target NWDAF with AnLF. The third network entity may be a NWDAF with MTLF.

The second indication provided by the first network entity to the third network entity may provide the third network entity with the information needed, to achieve the above-mentioned objectives, wherein the third network entity is the network entity that consumes the model accuracy information.

In an implementation of the first aspect, the first network entity is further configured to obtain the first indication to change the provisioning of model accuracy information based on least one of the following: by identifying that the model and/or the analytics ID associated with the provisioning of model accuracy information is related to an analytics transfer from the first network entity to the second network entity; by receiving from the second network entity any of the following: a model accuracy information context type, which indicates that transfer information related to the provisioning of accuracy information is to be included into analytics context information; a model accuracy information context flag, which indicates that the model accuracy information context type is to be requested; one or more parameters related to the provisioning of model accuracy information associated with the model.

The one or more parameters are also referred to as “Transfer information related to ML model accuracy generation” in this disclosure. The different ways of obtaining the first indication make the solution of the present disclosure compatible with existing standard procedures.

In an implementation of the first aspect, the first network entity is further configured to request the one or more parameters related to the provisioning of model accuracy information associated with the model from the second network entity, if the first indication is obtained by receiving the model accuracy information context type or the model accuracy information context flag from the second network entity.

This is an efficient way to request the parameters, which is compatible with existing standard procedures.

In an implementation of the first aspect, the first network entity is configured to provide the second indication to the third network entity included in a de-registration message or in a notification message with or without model accuracy information.

This is an efficient way to provide the second indication, which is compatible with existing standard procedures.

In an implementation of the first aspect, the second indication further comprises at least one of the following: a registration ID of the first network entity, which is related to the provisioning of model accuracy information associated with the model by the first network entity; a subscription ID of the third network entity at the first network entity, for the provisioning of model accuracy information associated with the model by the first network entity.

In an implementation of the first aspect, fourth information contains an ID of the second network entity, when the second network entity is registered as a provider of model accuracy information for the model and/or analytics ID.

A second aspect of this disclosure provides a third network entity for consuming model accuracy information for a model associated with a model identifier and/or analytics identifier, ID, wherein the model accuracy information denotes a quality information about the model, wherein the third network entity is configured to: consume model accuracy information associated with the model and/or an analytics ID, from a first network entity for generating model accuracy information for a model; and obtain a second indication from the first network entity or a second network entity, wherein the second indication comprises at least one of the following: a first information indicating a termination of a provisioning of model accuracy information for the model and/or analytics ID at the first network entity; a second information indicating a relocation of the provisioning of model accuracy information for the model and/or analytics ID from the first network entity to a second network entity; a third information indicating one or more changes related to the provisioning of model accuracy information for the model and/or analytics ID from the second network entity; a fourth information indicating a registration of the second network entity as a provider of model accuracy information for the model and/or analytics ID.

The third network entity is the network entity that consumes the model accuracy information. For instance, it may be the NWDAF with MTLF, while the first network entity and the second network entity are source and target NWDAF with AnLF, respectively. The third network entity may achieve the above-mentioned objectives, due to the receipt of the second indication from the first network entity.

In an implementation of the second aspect, the third network entity is further configured to: determine a relationship and/or mapping between the obtained second indication and the consumption of model accuracy information for the model and/or analytics ID by the third network entity; wherein the consumption of model accuracy information is associated with the model and one or more parameter information.

The reference to consumption of model accuracy information for the model and/or analytics ID is equivalent to the reference to the provisioning of model accuracy information for the model and/or analytics ID. The information related to these equivalent terms is the same. The difference is that the first term denotes this information from the point of view of the consumer of the information, while the latter describes the information from the point of view of the provider of such information. Furthermore, the term consumption of model accuracy information for the model and/or analytics ID or provisioning of model accuracy information for the model and/or analytics ID could also be referred to as subscription for model accuracy information for the model and/or analytics ID. When described from the point of view of the consumer, the term is referred to as subscription for model accuracy information for the model and/or analytics ID requested by the third network entity, while when described by the point of view of the provider the term is referred as subscription for the model and/or analytics ID provided by the first network entity (or second network entity).

In an implementation of the second aspect, the third network entity is configured to suspend usage of the data and/or one or processes related to consumption of model accuracy information from the first network entity based on a local configuration and/or based on the second indication if it comprises the first information or the second information.

This ensures that the third network entity does not attempt to execute changes on the data or processes related to a consumed model accuracy information from the first network entity, although the analytics transfer occurred and includes the transfer of model accuracy information.

In an implementation of the second aspect, for suspending the one or more processes associated with the consumption of model accuracy information, the third network entity is configured to: (a) stop changing or deleting for a determined period of time any of the following: data associated with the consumption of model accuracy information from the first network entity training or retraining process related to the model associated with the consumption of model accuracy information from the first network entity; or (b) pause the consumption of model accuracy information for a determined period of time, without changing or deleting any one of the following: a subscription for the consumption of model accuracy information from the first network entity; data associated with the consumption of model accuracy information from the first network entity; a process related to the consumption of model accuracy information from the first network entity.

In an implementation of the second aspect, the third network entity is configured to provide a request for a new provisioning of model accuracy information to the second network entity for generating model accuracy information, wherein the request is based on the second indication if it comprises the fourth information.

In an implementation of the second aspect, the third network entity is further configured to reuse or relocate or re-associate data and/or information from the one or more processes associated with the consumption of model accuracy information from the first network entity to the new provisioning of model accuracy information associated with the model and/or analytics ID from the second network entity.

This enables the third network entity to continue consuming the model accuracy information, now from the second network entity instead of the first network entity, even in case of an analytics transfer. The consumption of the model accuracy information may be continuous.

In an implementation of the second aspect, the third network entity is further configured to update information at the third network entity, which is related to the consumption of model accuracy information associated with the model and/or analytics ID from the second network entity, based on the second indication if it comprises the third information.

In an implementation of the second aspect, the third network entity is further configured to reuse or relocate or re-associate data and/or information from the one or more processes associated with the consumption of model accuracy information from the first network entity to the updated information related to the consumption of model accuracy information associated with the model and/or analytics ID from the second network entity.

In an implementation of the second aspect, the third network entity is further configured to resume the usage of the data and/or one or more processes related to the consumption of model accuracy information based on the second indication.

In an implementation of the second aspect, the third network entity is configured to determine that the second network entity is related to the suspended data and/or one or more processes related to the consumption of model accuracy information associated with the model and/or analytics ID provided by the first network entity, and to resume the usage of data and/or one or more processes related to consumption of model accuracy information from the first network entity.

In an implementation of the second aspect, for resuming the one or more processes related to the consumption of model accuracy information, the third network entity is configured to: reuse or relocate or re-associate data and/or information from the suspended one or more processes associated with the consumption of model accuracy information from the first network entity to the new provisioning of model accuracy information associated with the model and/or analytics ID from the second network entity.

In an implementation of the second aspect, the third network entity is further configured to, if the time period associated with the suspended one or more processes associated with a consumption of model accuracy information expires before the third network entity receives the third or fourth information from the second network entity, the third network entity is configured to de-activate the suspended one or more processes associated with consumption of model accuracy information and/or to delete data related to the suspended one or more processes associated with the consumption of model accuracy information.

A third aspect of this disclosure provides a method for generating model accuracy information for a model associated with an analytics identifier, ID, wherein the method is performed by a first network entity and comprises: obtaining a first indication to change a provisioning of model accuracy information, wherein the provisioning of model accuracy information is consumed by a third network entity for training models and is associated with the model and one or more parameter information, and wherein the model accuracy information denotes a quality information about the model; and providing a second indication related to a change of the provisioning of model accuracy information to the third network entity based on the first indication, wherein the second indication comprises at least one of the following: a first information indicating a termination of the provisioning of model accuracy information for the model and/or the analytics ID at the first network entity; a second information indicating a relocation of the provisioning of model accuracy information for the model and/or analytics ID from the first network entity to a second network entity; a third information indicating one or more changes related to the provisioning of model accuracy information for the model and/or analytics ID; a fourth information indicating a registration of the second network entity as a provider of model accuracy information for the model and/or analytics ID in accordance with the first indication.

The method of the third aspect may have implementation forms, which correspond to the implementation forms of the first network entity of the first aspect. The method of the third aspect and its implementation forms may achieve the same objectives and advantages as the first network entity of the first aspect and its respective implementation forms.

A fourth aspect of this disclosure provides a method for consuming model accuracy information for a model, wherein the model accuracy information denotes a quality information about the model, wherein the method is performed by a third network entity and comprises: consuming model accuracy information associated with the model and/or an analytics ID, from a first network entity for generating model accuracy information for a model associated with the analytics ID; and obtaining a second indication from the first network entity or a second network entity, wherein the second indication comprises at least one of the following: a first information indicating a termination of a provisioning of model accuracy information for the model and/or analytics ID at the first network entity; a second information indicating a relocation of the provisioning of model accuracy information for the model and/or analytics ID from the first network entity to a second network entity; a third information indicating one or more changes related to the provisioning of model accuracy information for the model and/or analytics ID from the second network entity; a fourth information indicating a registration of the second network entity as a provider of model accuracy information for the model and/or analytics ID.

The method of the fourth aspect may have implementation forms, which correspond to the implementation forms of the third network entity of the second aspect. The method of the fourth aspect and its implementation forms may achieve the same objectives and advantages as the third network entity of the second aspect and its respective implementation forms.

A fifth aspect of this disclosure provides a computer program comprising instructions which, when the program is executed by a computer, cause the computer to perform the method according to the third aspect or the fourth aspect or any implementation form thereof.

A sixth aspect of this disclosure provides a non-transitory storage medium storing executable program code which, when executed by a processor, causes the method according to the third aspect or fourth aspect or any of its implementation forms to be performed.

In sum, the present disclosure provides the following advantages. Firstly, it enables a relocation or termination of providing model accuracy information to the third network entity, for instance, the NWDAF with MTLF. Secondly, it allows and update of monitoring the ML model accuracy information by the third network entity.

It will be appreciated that embodiments described in the present application may include software or hardware elements or a combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or a combination thereof.

### BRIEF DESCRIPTION OF DRAWINGS

The above described aspects and implementation forms will be explained in the following description of specific embodiments in relation to the enclosed drawings, in which

FIG. 1 shows a first network entity according to this disclosure, a second network entity, and a third network entity according to this disclosure.

FIG. 2 shows the first network entity (source NWDAF with AnLF), the second network entity (target NWDAF with AnLF), and the third network entity (NWDAF with MTLF) in a system architecture, which is related to the generation and provisioning of model accuracy information, and supports relocating the model accuracy information.

FIG. 3 shows source triggered analytics transfer procedures with a source NWDAF triggered MTLF preparation for relocating the provisioning of model accuracy information (alternative A).

FIG. 4 shows source triggered enhanced analytics transfer procedures with a source NWDAF triggered MTLF preparation for relocating the provisioning of model accuracy information (alternative B).

FIG. 5 shows source triggered enhanced analytics transfer procedures with a target NWDAF triggered MTLF preparation for relocating the provisioning of model accuracy information (alternative C).

FIG. 6 shows target triggered analytics transfer procedures with a source NWDAF triggered MTLF preparation for relocating the provisioning of model accuracy information (alternative D).

FIG. 7 shows target triggered analytics transfer procedures with a target NWDAF triggered MTLF preparation for relocating the provisioning of model accuracy information (alternative E).

FIG. 8 shows a method for generating model accuracy information according to this disclosure, wherein the method may be performed by the first network entity.

FIG. 9 shows a method for consuming model accuracy information according to this disclosure, wherein the method may be performed by the third network entity.

### EXPLANATION OF TERMS USED IN THIS DISCLOSURE

ML Model Accuracy Context flag: indicates to a NWDAF with AnLF that the ML model Accuracy Monitoring Context Type should be requested when executing an analytics context transfer procedure.

ML Model accuracy Monitoring (or generation or provisioning) Context Type: is an information that denotes a request (or is an indication) to include in the analytics context information the Transfer information related to ML model accuracy generation. This indication allows the target NWDAF with AnLF to request to the source NWDAF with AnLF the information to trigger the ML model accuracy information monitoring based on previous parametrization (or information) used by the source NWDAF with AnLF for the generation of the ML Model accuracy information.

Transfer information related to ML model accuracy generation (source NWDAF with AnLF→target NWDAF with AnLF: denotes information (or one or more parameters) related to an existing subscription to provide ML Model accuracy information related to an analytics ID, where such analytics ID is further related to a ML model and/or an analytics transfer process (or analytics transfer procedure, or to a need to transfer the analytics ID). A synonym of this term is ML Model accuracy monitoring related information. This information can contain any of the following:
ML Model accuracy activation flag: indicates to target NWDAF with AnLF and with accuracy checking capability (e.g., the capability of generating analytics accuracy information and/or ML model accuracy information) of the need to activate the ML Model accuracy checking (or ML Model accuracy monitoring) associated with the ML Model related to an analytics ID that is being transferred from a source NWDAF with AnLF to a target NWDAF with AnLF.
ML Model accuracy context flag. This parameter can also be used standalone, without being part of the Transfer information related to ML model accuracy generation.
ML Model accuracy subscription identification at source NWDAF (e.g., original subscription ID for ML Model accuracy).
ML Model Accuracy Information Relocation (or Termination) indication: Indicates to the target NWDAF that the source NWDAF with AnLF terminated (or will terminate) the generation of ML Model accuracy information associated with the analytics ID related to the analytics transfer. This indication can also be understood as the source NWDAF with AnLF indicating to the target NWDAF with AnLF that a relocation of the subscription to the ML Model Accuracy information related to the analytics ID is required.
ML Model Accuracy Information Split indication: indicates to the target NWDAF that the source NWDAF with AnLF will retain (will keep) the subscription for the ML model accuracy information for the analytics ID related to an analytics transfer. In other words, indicates that both source and target NWDAF with AnLF are capable of (or are responsible for or have a subscription for) generating ML Model Accuracy information for the analytics ID related to an analytics transfer.
Accuracy metrics monitored at the source NWDAF with AnLF, where the accuracy metrics define the one or more metrics to calculate the accuracy information for a ML model.
Accuracy Reporting Threshold(s): to indicate the reporting condition which the ML Model accuracy information needs to be reported.
Accuracy Reporting Period: to indicate the reporting periodicity in which the ML Model accuracy information can be reported.
Notification endpoint of service operation (e.g., the Nnwdaf_MLModelMonitor_Notify service operation) at the NWDAF containing MTLF consuming the ML Model accuracy information.
Identification of the existing ML Model Monitoring subscription (e.g., Subscription Correlation ID for the ML Model accuracy information subscription request).

ML Model accuracy transfer indication (NWDAF with AnLF→NWDAF with MTLF): information related to an existing subscription for ML model accuracy information for a ML model and/or analytics ID. This indication comprises any of the following:
Original (or Existing) Subscription identification for the ML model accuracy information related to the subscription at the source NWDAF with AnLF.
New subscription ID related to the subscription for ML Model accuracy information at the target NWDAF with AnLF.
ML Model identification (e.g., unique ML Model identification).
One or more Analytics ID.
NF ID of NWDAF containing AnLF related to the target NWDAF (e.g., the NF identification of the NWDAF with AnLF that received the analytics transfer).
Subscription endpoint of service operation (e.g., the Nnwdaf_MLModelMonitor_Subscribe service operation) at the target NWDAF containing AnLF.
Accuracy metrics being monitored at the source NWDAF with AnLF.
Type of ML model accuracy subscription transfer. Examples of possible types of ML model accuracy subscription transfer:
   Split: indicates that both source and target NWDAF with AnLF are capable of (synonyms in this invention for this term are: are responsible for or have a subscription for) generating ML Model Accuracy information for the analytics ID related to an analytics transfer.
   Relocation: indicates that only the target NWDAF with AnLF is capable of (or are responsible for or have a subscription for) generating ML model Accuracy information for the analytics ID related to an analytics transfer.
Set of UEs associated with transferred subscription for ML model accuracy.

ML Model accuracy Provisioning Termination: information that indicates to the NWDAF with MTLF that a registration and/or a subscription related to ML model accuracy monitoring for an analytics ID is terminated. It can comprise any of the following:
ML Model Accuracy Monitoring Termination (e.g. implemented as a flag): indicates any of the following: a) the deregistration of an NWDAF with AnLF as capable of serving ML Model accuracy information for an analytics ID; b) the unsubscription (e.g., cancelation of a subscription) of an NWDAF with AnLF for ML Model Accuracy information.
ML Model Accuracy Monitoring Termination Cause: indicates the cause for the de-registration and/or unsubscription for the ML Model Accuracy Monitoring. Examples of possible causes are: “de-registration due analytics transfer”, “termination due to relocation of analytics ID”.
NWDAF containing AnLF NF ID of the target NWDAF (e.g., the NF identification of the NWDAF with AnLF that received the analytics ID, that was associated with the Model accuracy monitoring subscription for analytics ID at the source NWDAF with AnLF).
Original (or Existing or at the source NWDAF with AnLF) Subscription identification (also referred as subscription correlation ID) for the ML model accuracy information related to the subscription at the source NWDAF with AnLF.
Subscription endpoint of the Nnwdaf_MLModelMonitor_Subscribe service operation at the target NWDAF containing AnLF.
ML Model identification (e.g., unique ML Model identification).
One or more Analytics ID.
ID of the analytics consumer (e.g., per analytics ID).
Original (or Existing) Subscription identification (also referred as subscription correlation ID) for the analytics output at the source NWDAF with AnLF.
Backoff timer indicating to the NWDAF with MTLF to wait for a period of time before triggering changes in the processes related to the ML Model (e.g., unique ML Model identification) related to the NWDAF with AnLF that indicated the de-registering. Examples of these processes are any of the following:
   a) purge (or clean up, or stop) training or retraining related to the ML Model associated with the NWDAF with AnLF that indicated the de-registering;
   b) purge (or clean up, or stop) model re-selection for analytics ID related to NWDAF with AnLF that indicated the de-registering;
   c) purge (or clean up, or stop) tagging of collected data (or the selection of the collected data) from the NWDAF with AnLF that indicated the de-registering;
   d) purge (or clean up, or stop) data collection related to the NWDAF with AnLF that indicated the de-registering.

ML Model accuracy Provisioning Relocation: information that indicates to the NWDAF with MTLF that a new NWDAF with AnLF will start serving or is serving the ML model accuracy information for the same ML Model identification and/or analytics ID, where both are related to an existing subscription for ML model accuracy information with a different NWDAF with AnLF. It can comprise any of the following:
ML Model Accuracy Monitoring Relocation (e.g. implemented as a flag): indicates that a new NWDAF with AnLF will start serving or is serving the analytics ID associated with an existing subscription to ML Model accuracy information for such Analytics ID associated with the NWDAF with MTLF. Such flag allows or enables the NWDAF with MTLF to consider the ML model accuracy information completely detached from the subscription of the initial or source NWDAF with AnLF, or to bind the output (or notification) of the two subscriptions for ML Model accuracy information related to the same analytics ID into a single (or unique or centralized or combined or aggregated or associated or bind) of accuracy information for the ML Model.
NWDAF containing AnLF NF ID of the target NWDAF (e.g., the NF identification of the NWDAF with AnLF that received the analytics transfer with the relocation of the ML Model accuracy monitoring capability).
Subscription endpoint of the Nnwdaf_MLModelMonitor_Subscribe service operation at the target NWDAF containing AnLF.
Original (or Existing or at the source NWDAF with AnLF) Subscription identification (also referred as subscription correlation ID) for the ML model accuracy information related to the subscription at the source NWDAF with AnLF.
ML Model identification (e.g., unique ML Model identification).
One or more Analytics ID.
ID of the analytics consumer (e.g., per analytics ID).
Original (or Existing) Subscription identification (also referred as subscription correlation ID) for the analytics output at the source NWDAF with AnLF.
Backoff timer indicating to the NWDAF with MTLF to wait for a period of time before triggering changes in the processes related to the ML Model (e.g., unique ML Model identification) related to the NWDAF with AnLF that indicated the relocation. Examples of these processes are any of the following:
   a) purge (or clean up, or stop) training or retraining related to the ML Model associated with the NWDAF with AnLF that indicated the de-registering;
   b) purge (or clean up, or stop) model re-selection for analytics ID related to NWDAF with AnLF that indicated the relocation;
   c) purge (or clean up, or stop) tagging of collected data (or the selection of the collected data) from the NWDAF with AnLF that indicated the relocation;
   d) Purge (or clean up, or stop) data collection related to the NWDAF with AnLF that indicated the relocation.

Indication of changes related to ML Model accuracy generation: information that denotes that one or more analytics ID(s) or the data sources used for the ML Model accuracy generation have been changed since the last time the subscription for ML Model has been updated (e.g., since the last time the Nnwdaf_MLModelMonitor_Subscribe service has been invoke for updating the subscription for ML Model accuracy) or created (e.g., the first time the Nnwdaf_MLModelMonitor_Subscribe service has been invoke to create the subscription for ML Model accuracy information). This indication of changes related to ML Model accuracy generation can comprise any of the following:
A flag indicating changes in subscription.
Type of change, example of possible values are any of the following: including new analytics ID, removing analytics ID, including new data sources, removing data sources.
Reason of change: new subscription for analytics ID, un-subscription for analytics ID, receiving analytics ID transfer from a source NWDAF with AnLF, transferring analytics ID to a new NWDAF with AnLF.
One or more analytics ID.
ID of the analytics consumer.
Subscription Correlation ID associated with the subscription for the analytics ID output request.
Existing Subscription identification (also referred as subscription correlation ID) for the ML model accuracy information related to the subscription at the target NWDAF with AnLF.

ML Model accuracy transfer indication: information related to an existing subscription for ML model accuracy information for a ML model and/or analytics ID.

### DETAILED DESCRIPTION OF EMBODIMENTS

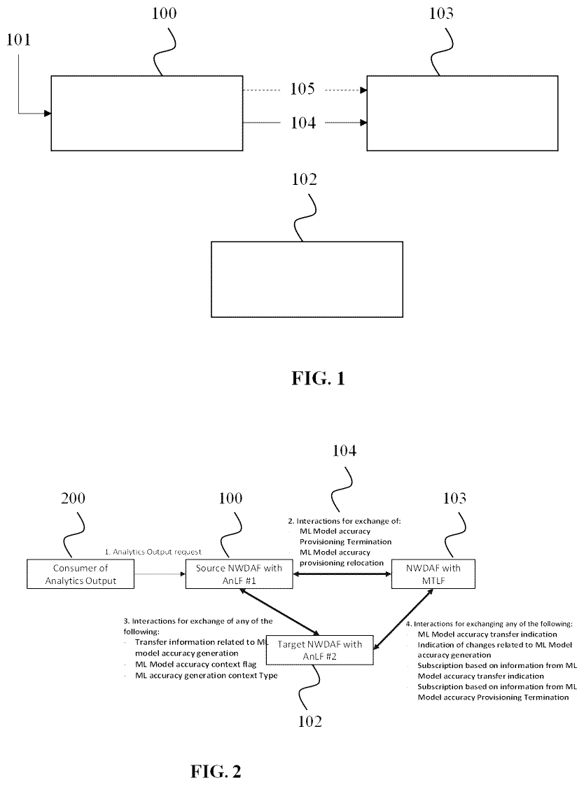

FIG. 1 shows a first network entity 100 for generating model accuracy information according to this disclosure, a second network entity 102, and a third network entity 103 for consuming modes accuracy information according to this disclosure.

The first network entity 100 is an entity suitable to generate the model accuracy information 105 for a model, which is associated with a model ID and/or an analytics ID. For instance, the first network entity 100 may be an NWDAF with AnLF. The first network entity 100 may particularly be a source NWDAF with AnLF in the example of FIG. 1. The second network entity 102 may also be an NWDAF with AnLF, and may in this example be a target NWDAF with AnLF. The third network entity 103 may be an NWDAF with MTLF in the example of FIG. 1.

The first network entity 100 is configured to obtain a first indication 101 to change a provisioning of the model accuracy information 105. There are several way to obtain the first indication 101 by the first network entity 100. For instance, the first network entity 100 may identify that the model and/or the analytics ID associated with the provisioning of the model accuracy information 105 is related to an analytics transfer from the first network entity 100 to the second network entity 102. For instance, the analytics ID may be relocated form the first network entity 100 to the second network entity 102. Further, the first network entity 100 may receive such indication 101 from the second network entity 102. For example, the first network entity 100 may receive any of a model accuracy information context type, a model accuracy information context flag, and one or more parameters related to the provisioning of the model accuracy information 105 from the second network entity.

The model accuracy information 105 is consumed by the third network entity 103. The third network entity 103 may use the consumed model accuracy information 105 for training models, particularly, the model associated with the model accuracy information 105. The third network entity 103 may also use the model accuracy information 105 to select one or more new models for the analytics ID. The third network entity 103 may provide the model associated with the model accuracy information 105 and/or any other model associated with or selected for the analytics ID. The model accuracy information 105 is associated with the model and with one or more parameter information, and denotes a quality information about the model.

The first network entity 100 may provide a second indication 104 to the third network entity 103. The second indication 104 is related to a change of the provisioning of model accuracy information 105 according to the first indication 101. The second indication 104 comprises at least one of first information, second information, third information, and fourth information. The third network entity 103, which consumes the model accuracy information 105 associated with the model and/or an analytics ID from the first network entity 100, may accordingly obtain the second indication 104 from the first network entity 100 (as shown). It could, alternatively, obtain the second indication 104 from the second network entity 102.

The first information indicates a termination of the provisioning of model accuracy information 105 for the model and/or the analytics ID at the first network entity 100. The second information indicates a relocation of the provisioning of model accuracy information 105 for the model and/or analytics ID from the first network entity to a second network entity 102. The third information indicates one or more changes related to the provisioning of model accuracy information 105 for the model and/or analytics ID. The fourth information indicating a registration of the second network entity 102 as a provider of model accuracy information 105 for the model and/or analytics ID in accordance with the first indication 101.

The first network entity 100 and the third network entity 103 may respectively comprise a processor or processing circuitry (not shown) configured to perform, conduct or initiate the various operations of the respective network entity 100, 103 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The first network entity 100 and the third network entity 103 may respectively further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective network entity 100, 103 to be performed. In one embodiment, the processing circuitry comprises one or more processors and a non-transitory memory connected to the one or more processors. The non-transitory memory may carry executable program code which, when executed by the one or more processors, causes the respective network entity 100, 103 to perform, conduct or initiate the operations or methods described herein.

The further disclosure focuses on the interactions of the network entities described in FIG. 1, specifically, for the exemplary case of the first and the second network entity 100, 102 respectively being source and target NWDAF with AnLF (also simply AnLF), and the third network entity 103 being the NWDAF with MTLF. The first and second network entity 100, 102 are enhanced with the capability to perform an analytics transfer, with extensions that support also the transfer of relevant information related to the generation of the model accuracy information 105.

FIG. 2 shows the first, the second, and the third network entity in a system architecture, which is configured for the generation, provisioning, and relocation of the model accuracy information 105. The system architecture is based on the 3GPP R18 specifications of the NWDAF. A consumer 200 of an analytics output initially interacts with the source NWDAF with AnLF 100, in order to request the consumption of analytics output, as depicted in Step 1 in FIG. 2.

When the source NWDAF with AnLF 100 starts the generation of analytics accuracy information for an analytics ID (e.g., because it received a request from the consumer 200 of the analytics output) and/or when it starts using a ML model for the analytics ID, the source NWDAF with AnLF 100 may trigger the interactions with the NWDAF with MTLF 103 (or also simply MTLF), as depicted in Step 2 in FIG. 2.

The NWDAF with AnLF 100 may register itself with the NWDAF with MTLF 103. For instance, 3GPP TS 23.288 defines the service Nnwdaf_MLModelMonitor_Register for the execution of such a registration procedure. This registration of the NWDAF with AnLF 100 denotes that it is capable of serving ML model accuracy information 105 for the NWDAF with MTLF 103, which is providing the ML model used for generating the analytics output by the NWDAF with AnLF 100. Additionally, as defined in TS 23.288, this registration and/or local policies will make (or trigger) the NWDAF with MTLF 103 to request to the registered NWDAF with AnLF 100 to generate the ML model accuracy information 105. An example of how this request can be enforced is defined in TS 23.288 with the service Nnwdaf_MLModelMonitor_Subscribe, where the input parameters are: Analytics ID(s), unique identifier(s) of the ML model(s) to be monitored, accuracy metrics to be monitored, optionally reporting threshold(s) or reporting period.

The NWDAF with AnLF 100 receives the request and starts the mechanisms (or processes) for accuracy monitoring for ML Model (also referred to as ML model accuracy generation) and providing the generated ML model accuracy information 105 for the NWDAF with MTLF 103 that subscribed for such information.

Meanwhile it is possible that, due to different reasons, an analytics transfer procedure is triggered, for example, as defined in TS 23.288 Clause 6.1B. Examples of such reasons are the NWDAF with AnLF 100 needs to shut down, or is overloaded and decides to move some subscriptions for the analytics ID to other NWDAFs, or UEs that are target of the analytics ID being generated move to a different area of the network that is not served by the NWDAF with AnLF 100, and therefore a new target NWDAF with AnLF 102 needs to take over the generation of the analytics ID for such UEs, as well as all the other processes related to such analytics ID, for instance the ML model accuracy information generation.

Independent from the above reasons, this disclosure specifically defines the interactions and information exchange that enables a subscription to ML model accuracy information 105 monitoring (or generation) to be relocated (or rebind, or remapped or relinked or transferred) to a new NWDAF with AnLF 102 that is now capable of serving the ML model accuracy information 105 for the analytics ID and/or ML model. For instance, of serving a new subscription that is associated to an existing ML Model accuracy information subscription, which has been transferred to or needs to be started in the new NWDAF with AnLF 102. These interactions and associated information are summarized as follows.

Interactions between source NWDAF with AnLF 100 and NWDAF with MTLF 103 (Step 2 in FIG. 1), where at least one of the following information is exchanged among such entities: ML Model accuracy Provisioning Termination, ML Model accuracy provisioning relocation.

Interactions between source NWDAF with AnLF 100 and target NWDAF with AnLF 102 (Step 3 in FIG. 1), where at least one of the following information is exchanged among such entities: transfer information related to ML model accuracy generation, ML Model accuracy context flag, ML accuracy generation context Type.

Interactions between target NWDAF with AnLF 102 and the NWDAF with MTLF 103 (that is consuming ML model accuracy information from the source NWDAF with AnLF 100), where at least one of the following information is exchanged among such entities: ML model accuracy transfer indication, subscription based on information from ML model accuracy transfer indication, Subscription based on information from ML Model accuracy Provisioning Termination, Indication of changes related to ML Model accuracy generation.

The specific cases for the exchange of each of such information in each step depicted in FIG. 2 are described in details of the embodiments of this disclosure.

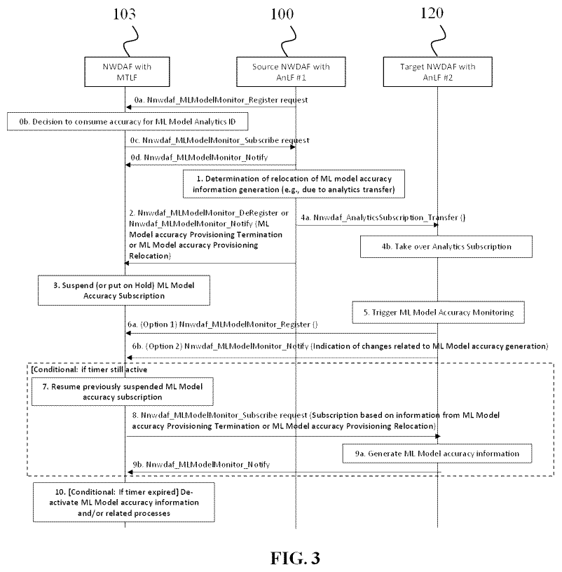

In the following, more specific exemplary embodiments of this disclosure are described. All the exemplary embodiments of this disclosure consider the 5G network architecture defined by 3GPP and documented in TS 23.501. Specifically, the embodiments are focused on the extensions related to the NWDAF Network Function, which is defined in the 3GPP TS 23.288 specification. The exemplary embodiments base on the procedures (alternatives) shown in and described with reference to the FIGS. 3-7.

It is also possible in further embodiments of the alternatives depicted in FIGS. 3-7 that no explicit mechanism of suspend and resume of a subscription, its data and/or one or more related processes (e.g., data collection) is performed at the NWDAF with MTLF. In these possible embodiments, the steps depicted in FIGS. 3-7 for suspending and resuming the processes at the NWDAF with MTLF (third network entity 103) are not necessary. Instead, the NWDAF with MTLF is still able to interact with the Source and/or Target NWDAF with AnLF, and is capable to determine the mapping between the provisioning of model accuracy information 105 from the source NWDAF with AnLF (first network entity 100) to the provisioning of model accuracy information 105 from the target NWDAF with AnLF (second network entity 102), e.g., by reusing or re-associating the data and/or one or more processes related to the provisioning of model accuracy information 105 from the source NWDAF with AnLF to the provisioning of model accuracy information 105 from the target NWDAF with AnLF.

FIG. 3 shows an alternative A: source triggered analytics transfer procedures with source NWDAF 100 triggered MTLF preparation for ML model accuracy provisioning relocation. This alternative is aimed at preserving the analytics transfer procedures with none or very minor changes and concentrate the changes in order to relocate a ML model accuracy information monitoring process (also referred as relocation of ML Model accuracy information subscription) in the interactions between source NWDAF with AnLF 100 and NWDAF with MTLF 103. The changes are then concentrated in extensions of Nnwdaf_MLModelMonitor service operations such as Register, Deregister, Subscribe, and Notify.

Step 0. These steps are executed when the source NWDAF with AnLF 100 identified that it is capable to generate ML Model accuracy information 105 for an NWDAF with MTLF 103. This means that the Source NWDAF 100 identified that it is using a given ML Model provided by a certain NWDAF with MTLF 103, and that the Source NWDAF with AnLF 100 is able to monitor the ML Model accuracy information 105. The Source NWDAF with AnLF 100 executes such identification when it based on local policies it start monitoring the analytics accuracy information for an analytics ID or when it received a feedback from the NF consumer of an analytics ID. Based on such identification the Source NWDAF 100 triggers the follow steps (which are executed before any analytics transfer procedures are taking place):

Step 0a: The Source NWDAF with AnLF 100 invokes a service from the NWDAF with MTLF 103 related to the ML model that such NWDAF with AnLF 100 is able to monitor the ML Model accuracy information 105. For instance, the Source NWAF 100 could invoke the service “Nnwdaf_MLModelMonitor_Register” as defined in TS 23.288 to indicate that it is registering with the NWDAF with MTLF 103 as a provider of ML accuracy information 105 for a given ML model.

Step 0b: NWDAF with MTLF 103 decides to request the ML Model accuracy information 105 from a (Source) NWDAF with AnLF 100 capable to provide such information for a certain model. This decision can be based on local policies and/or when it receives a registration of a NWDAF with AnLF indicating that it is able to provide the ML Model accuracy information 105 for a ML model.

Step 0c: NWDAF with MTLF 103 subscribes to the service offered by (Source) NWDAF with AnLF 100 capable to serve the ML Model accuracy information 105 for the desired ML Model. The NWDAF with MTLF 103 can invoke for instance the service “Nnwdaf_MLModelMonitor_Subscribe” in order to request a subscription for the ML Model accuracy information 105.

Step 0d: Source NWDAF with AnLF 100 notifies the NWDAF with MTLF 103 with the calculated ML Model accuracy information 105. An example of service that can be used to deliver the notification with the ML Model Accuracy information 105 is the service “Nnwdaf_MLModelMonitor_Notify”.

Step 1. The Source NWDAF with AnLF 100 identifies the need to perform analytics transfer. When preparing the information for transferring the analytics subscription related to an analytics ID to a target NWDAF with AnLF 102, the source NWDAF with AnLF 100 identifies that for such analytics ID and/or analytics ID associated ML Model there is an existing subscription from a NWDAF with MTLF 103 to receive ML Model accuracy information 105.

Step 2. Based on the identification of the need for performing analytics transfer and the existence of a ML model accuracy subscription from a NWDAF with MTLF 103 related to the analytics ID and/or ML Model that are related to the analytics transfer procedure, the Source NWDAF with AnLF 100 provides the ML Model accuracy Provisioning Termination or indication ML Model accuracy Provisioning relocation to the NWDAF with MTLF 103 related to the existent ML model accuracy subscription. Such indication can be implemented in any of the ways described below:

Option 1: Implementation via De-Registration service: In this case, the Source NWDAF with AnLF 100 invokes the “Nnwdaf_MLModelMonitor_Deregister” service including any of the following parameters: an information that identifies the registration of the NWDAF with AnLF serving the ML Model accuracy information 105, e.g., a registration or subscription identification (or subscription correlation ID), and the ML Model accuracy Provisioning Termination or the ML Model accuracy Provisioning Termination.

Option 2: Implementation via Notification: In this case, the Source NWDAF with AnLF 100 invokes the “Nnwdaf_MLModelMonitor_Notify” including any of the following parameters: subscription identification (or subscription correlation ID) and the ML Model accuracy Provisioning Termination or the ML Model accuracy Provisioning Termination.

Step 3. Based on the ML Model accuracy Provisioning Termination or the ML Model accuracy Provisioning Termination received from the Source NWDAF with AnLF 100, the NWDAF with MTLF 103 determines that before deleting all the data related to a subscription for ML Model accuracy information 105 (e.g., previous records of ML Model accuracy information, and/or association of the ML Model accuracy to ML Model identifications, and/or association of ML model accuracy information 105 to further data collection processes) and/or purging (or stopping, or deleting) any other processes related to (or triggered based on or configured to be triggered based on) the ML model accuracy information, the NWDAF with MTLF 103 suspend for a period of time the subscription for ML Model accuracy information without enforcing any changes to such subscription and/or associated data and/or associated processes. The NWDAF with MTLF 103 may use the information received from the source NWDAF with AnLF 100 (e.g., the backoff trigger comprised in the received ML Model accuracy Provisioning Termination or the ML Model accuracy Provisioning Termination), or use information configured locally to trigger the process of waiting for a new registration via Nnwdaf_MLModelMonitor_Register service and/or a new Notification via Nnwdaf_MLModelMonitor_Notify from a new NWDAF with AnLF 102 taking over the suspended subscription for ML Model accuracy provisioning.

Step 4. The source NWDAF with AnLF 103 triggers the analytics transfer to a target NWDAF with AnLF 102. In this case, no change is required in the transfer procedures when source NWDAF invokes the Nnwdaf_AnalyticsSubscription_Transfer( ) service. The Target NWDAF with AnLF 102 receive the request for analytics transfer from the source NWDAF with AnLF 100 and triggers the processing for retrieving the analytics context information (if required) from such source NWDAF with AnLF 100. The Target NWDAF 102 finally completes the analytics transfer procedure and takes over the analytics output generation.

NOTE 1: Steps 4 or 2 and 3 can happen in parallel or in any order.

Step 5. Based on its internal logic and/or based on an indication for providing analytics accuracy information associated with the analytics ID received by the source NWDAF with AnLF 100 (for instance as described in TS 23.288), the Target NWDAF with AnLF 102 determines that it should also trigger the monitoring of ML Model accuracy information associated with the analytics ID and/or ML Model related to the new activated analytics output subscription resulting from the analytics transfer procedure.

Step 6. (a—Option 1) If the Target NWDAF with AnLF 102 had not yet registered itself as a provider of ML Model accuracy information for the ML Model used by the analytics ID that has been transferred, the NWDAF with AnLF 102 invokes the “Nnwdaf_MLModelMonitor_Register” service in order to register itself as a provider of the ML Model accuracy information for a ML Model (e.g., identified with a unique ML Model identification) and/or the analytics ID, potentially including further parameters such as, subscription endpoint of the Nnwdaf_MLModelMonitor_Subscribe service operation at the Target NWDAF containing AnLF. Additionally the NWDAF containing AnLF NF ID parameter related to the target NWDAF with AnLF 102 is added in the “Nnwdaf_MLModelMonitor_Register” service request parameters in order to allow the NWDAF with MTLF 103 to determine if the registration is related to a suspended subscription for ML Model accuracy information. In such a case, the NWDAF containing AnLF NF ID parameter can be equivalent to the indication of subscription changes.

Step 6 (b—Option 2) If the Target NWDAF with AnLF 102 had already registered as a ML Model Accuracy information provider (also referred as NWDAF with AnLF that is able to monitor the ML Model accuracy of the ML Model), the Target NWDAF with AnLF 102 provide to the NWDAF with MTLF 103 an indication of changes related to ML Model accuracy generation (or also referred as indication of subscription change). For instance, the Target NWDAF 102 provides a notification using the Nnwdaf_MLModelMonitor_Notify service that includes the indication of subscription change. This notification can contain only the indication of subscription change or the indication of subscription change and the generated ML Model Accuracy information.

NOTE 2: Step 7 to 9 are executed if the timer for the suspended ML Model accuracy subscription has not expired.

Step 7. The NWDAF with MTLF 102 based on the ML Model accuracy Provisioning Termination or ML Model accuracy Provisioning Relocation and the information received from the Target NWDAF with AnLF 102, the NWDAF with MTLF 103 determines that Target NWDAF with AnLF 102 is related to the suspended ML Model Accuracy subscription and then resumes such subscription.

The following possible situations may apply for the determination to resume a suspended ML Model accuracy subscription.

(If Step 6a was executed) If the Target NWDAF with AnLF 102 used the Nnwdaf_MLModelMonitor_Register service operation to register itself, the NWDAF with MTLF 103 is able to map the NWDAF containing AnLF NF ID received in the registration to the NWDAF containing AnLF NF ID of the target NWDAF included in the ML Model accuracy Provisioning Termination or ML Model accuracy Provisioning Relocation received from the source NWDAF with AnLF 100. This mapping allows the NWDAF with MTLF 103 to identify that the target NWDAF with AnLF 102 is now the new provider for the ML Model accuracy information related to the suspended subscription.

(If step 6b was executed) If the Target NWDAF with AnLF 102 used the Nnwdaf_MLModelMonitor_Notify service, this means that the target NWDAF with MTLF compares any of the following information comprised in the ML Model accuracy Provisioning Termination or ML Model accuracy Provisioning Relocation received from the source NWDAF with AnLF 100—analytics ID(s), ID of the analytics consumer, Subscription Correlation ID associated with the subscription for the analytics ID output request—with the same information received from target NWDAF with AnLF 102 comprised in the parameters of the Nnwdaf_MLModelMonitor_Notify service (i.e., the indication of subscription change information comprised in the notification of such service). If one or more of these parameters are the same, the NWDAF with MTLF 103 is able to determine that the existing subscription for ML Model accuracy information with the target NWDAF with AnLF 102 is also related to the suspended subscription for ML Model accuracy information. This mapping allows the NWDAF with MTLF 103 to identify that the target NWDAF with AnLF 102 is now the new provider for the ML Model accuracy information related to the suspended subscription.

The process of resuming a suspended subscription for ML Model accuracy information relates to the re-association of parametrization of the ML Model generation, and/or data and/or MTLF processes (e.g., ML Model re-training, ML Model re-selection) to the target NWDAF with AnLF 102. In other words, resuming a suspended subscription for ML Model accuracy information means reusing or moving or re-associating the data and/or the information from the suspended subscription to the subscription (new or existing) for ML Model accuracy information related to the target NWDAF 102.

NOTE 3: If the NWDAF with MTLF 103 does not perform the process of suspending the subscription for the ML Model accuracy information 105 from the source NWDAF with AnLF 100, such NWDAF with MTLF 103 is anyway able to perform re-association of parametrization of the ML Model generation, and/or data and/or MTLF processes (e.g., ML Model re-training, ML Model re-selection) by relating the information received in Step 2 to the information received in Step 6. In this case, the Steps 3, 7 and 10 are not executed, and only Steps 8 and 9 are executed. Further references in this application to suspended subscription can also be understood as a “reassigned subscription”. This is a simplification of the text to express the full sentence “reused or moved or reassigned data and/or parameters and/or one or more processes related to a subscription for ML model accuracy from a source NWDAF with AnLF”.

Step 8. When the NWDAF with MTLF 103 determines it should resume the previously suspended subscription for ML Model accuracy information (associated with the source NWDAF with AnLF) or re-associate (or reuse, or move or copy) parametrization and/or data and/or processes to the new target NWDAF with AnLF 102 able to provide the ML model accuracy information 105, the NWDAF with MTLF 103 invokes the Nnwdaf_MLModelMonitor_Subscribe request from the Target NWDAF with AnLF 102 in order to request a new subscription for receiving ML Model accuracy information related to the ML model and/or analytics IDs associated with the suspended subscription; or to update the an existing subscription with target NWDAF with AnLF 102. In both cases, the NWDAF with MTLF subscription parameters are based on the information from ML Model accuracy Provisioning Termination or ML Model accuracy Provisioning Relocation or parameters related to the suspended subscription, enabling the usage in the new NWDAF of the same parametrization being used by the suspended subscription.

Step 9. Based on the subscription information received from NWDAF with MTLF 103, the Target NWDAF with AnLF 102 starts the generation (or monitoring) of ML Model accuracy information and provides such information using the Nnwdaf_MLModelMonitor_Notify service operation to the target NWDAF with AnLF 102.

Step 10. [Conditional: If the timer for the suspended subscription expired] If the expiration time associated with the suspended subscription expires and NWDAF with MTLF 103 did not receive any new registration request or a notification from a different NWDAF with AnLF from the one associated with the suspended subscription, the NWDAF with MTLF 103 will consider that such suspended subscription should be de-activated. It will delete all data related to such suspended subscription.

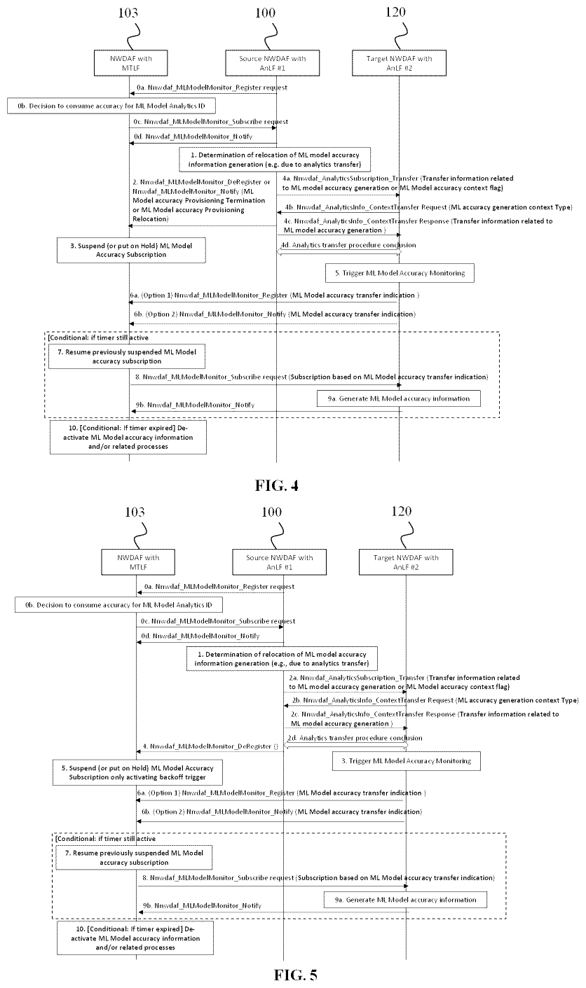

FIG. 4 shows alternative B: Source triggered enhanced analytics transfer procedures with Source NWDAF triggered MTLF preparation for ML model accuracy provisioning relocation. This alternative is aimed at enabling transparency in the processes of relocating a ML Model accuracy information monitoring process (also referred as relocation of ML Model accuracy information subscription). In this case, there are changes in the analytics transfer procedures and in the interactions between source NWDAF with AnLF 100 and NWDAF with MTLF 103.

NOTE: Steps 0 to 3 in FIG. 4 are the same as Steps 0 to 3 in FIG. 3, therefore the description is provided in the text above. In this case, the possible embodiment where the NWDAF with MTLF 103 is not suspending and resuming a subscription are also aligned with the same description related to FIG. 3.

Step 4. The source NWDAF with AnLF 100 triggers the analytics transfer to a target NWDAF with AnLF 102. In this case, the source NWDAF 100 invokes the Nnwdaf_AnalyticsSubscription_Transfer( ) request service operation from the target NWDAF with AnLF 102 including either the Transfer information related to ML model accuracy information generation or ML Model accuracy context flag.

When the transfer information related to ML model accuracy information generation is included the steps 4b and 4c can be skip because all the relevant information to trigger the ML Model Accuracy monitoring for the ML Model related to the analytics ID being transfer is enclosed in the transfer information.

When only the ML Model accuracy context flag is included in the Nnwdaf_AnalyticsSubscription_Transfer( ) service request, the ML Model accuracy context flag indicates to the target NWDAF with AnLF 102 that the analytics context information has to be retrieved, therefore step 4b and 4c have to be executed and when retrieving the analytics context, the target NWDAF with AnLF 102 needs to request the Transfer information related to ML model accuracy generation. This is achieved by the target NWDAF with AnLF 102 requesting the Nnwdaf_AnalyticsInfo_ContextTransfer service operation from the source NWDAF with AnLF 100 and including in the request the ML accuracy generation context Type. Based on the received ML accuracy generation context Type the source NWDAF with AnLF 100 includes in the Nnwdaf_AnalyticsInfo_ContextTransfer response to the target NWDAF with AnLF 102 the Transfer information related to ML model accuracy generation (potentially comprised in the analytics context information). The target NWDAF with AnLF 102 then finalizes the analytics transfer procedure.

Step 5. Based on the Transfer information related to ML model accuracy generation received from the source NWDAF with AnLF 100, the Target NWDAF with AnLF 102 triggers the monitoring of ML Model accuracy information 105 associated with the analytics ID and/or ML Model received during the analytics transfer procedure.

Step 6 (a—Option 1) If the Target NWDAF with AnLF 102 had not yet registered itself as a provider of ML Model accuracy information for the ML Model used by the analytics ID that has been transferred, the NWDAF with AnLF 102 invokes the “Nnwdaf_MLModelMonitor_Register request” operation from the NWDAF with MTLF 103 in order to register itself as a provider of the ML Model accuracy information 105 for a ML Model (e.g., identified with a unique ML Model identification) and/or the analytics ID, potentially including further parameters such as, subscription endpoint of the Nnwdaf_MLModelMonitor_Subscribe service operation at the Target NWDAF 102 containing AnLF. Additionally the target NWDAF containing AnLF 102 includes the ML Model accuracy transfer indication in the “Nnwdaf_MLModelMonitor_Register” service request parameters in order to allow the NWDAF with MTLF 103 to determine if the registration is related to a suspended subscription for ML Model accuracy information.

Step 6 (b—Option 2) If the Target NWDAF with AnLF 102 had already registered as a ML Model Accuracy information provider (also referred as NWDAF with AnLF that is able to monitor the ML Model accuracy of the ML Model), the Target NWDAF with AnLF 102 provides to the NWDAF with MTLF 103 the ML Model accuracy transfer indication using the Nnwdaf_MLModelMonitor_Notify service. This notification can contain only the ML Model accuracy transfer indication or the ML Model accuracy transfer indication and the generated ML Model Accuracy information.

Step 7. The NWDAF with MTLF 103 based on the ML Model accuracy Provisioning Termination or ML Model accuracy Provisioning Relocation and the ML Model accuracy transfer indication received from the Target NWDAF with AnLF 102, the NWDAF with MTLF 103 determines that Target NWDAF with AnLF 102 is related to the suspended ML Model Accuracy subscription and then resumes such subscription.

Step 8. When the NWDAF with MTLF determines it should resume the previously suspended subscription for ML Model accuracy information (associated with the source NWDAF with AnLF), the NWDAF with MTLF 103 invokes the Nnwdaf_MLModelMonitor_Subscribe request from the Target NWDAF with AnLF 102 in order to request a new subscription for receiving ML Model accuracy information related to the ML model and/or analytics IDs associated with the suspended subscription; or to update the an existing subscription with target NWDAF with AnLF 102. In both cases, the NWDAF with MTLF subscription parameters are based on the information from ML Model accuracy Provisioning Termination or ML Model accuracy Provisioning Relocation or ML Model accuracy transfer indication.

NOTE: Steps 9 and 10 in FIG. 4 are the same as Steps 9 and 10 in FIG. 3, therefore the description is provided in the text above.

FIG. 5 shows an alternative C: Source triggered enhanced analytics transfer procedures with target NWDAF triggered MTLF preparation for ML model accuracy provisioning relocation. This alternative is aimed at concentrating at the Target NWDAF with AnLF 102 the responsibility to relocating a ML Model accuracy information monitoring process (also referred as relocation of ML Model accuracy information subscription). In this case, there are changes in the analytics transfer procedures and in the interactions between target NWDAF with AnLF 102 and NWDAF with MTLF 103.

NOTE 1: Steps 0 and 1 in FIG. 5 are the same as Steps 0 and 1 in FIG. 3, therefore the description is provided in the text above.

NOTE 2: Step 2 and 3 in FIG. 5 are respectively the same as Step 4 and 5 in FIG. 4, therefore the description is provided in the text above.

Step 4. The source NWDAF with AnLF 100 de-registers from the NWDAF invoking the Nnwdaf_MLModelMonitor_DeRegister ( ) service operation provided by the NWDAF with MTLF 103.

Step 5. When the NWDAF with MTLF 103 receives a de-registration request from an NWDAF with AnLF and based on its internal logic, the NWDAF with MTLF 103 determines that before deleting all the data related to a subscription for ML Model accuracy information (e.g., previous records of ML Model accuracy information, and/or association of the ML Model accuracy to ML Model identifications, and/or association of ML model accuracy information to further data collection processes) and/or purging (or stopping, or deleting) any other processes related to (or triggered based on or configured to be triggered based on) the ML model accuracy information, the NWDAF with MTLF 103 suspends for a period of time the subscription for ML Model accuracy information without enforcing any changes to such subscription and/or associated data and/or associated processes. The NWDAF with MTLF may use information configured locally to trigger the process of waiting for a new registration via Nnwdaf_MLModelMonitor_Register service and/or a new Notification via Nnwdaf_MLModelMonitor_Notify from a new NWDAF with AnLF 102 taking over the suspended subscription for ML Model accuracy provisioning.

NOTE 3: Step 6 in FIG. 5 5 is the same as Step 6 in FIG. 4, therefore the description is provided in the text above.

Step 7. The NWDAF with MTLF 103 based on ML Model accuracy transfer indication—received from the Target NWDAF with AnLF 102—is able to determine that Target NWDAF with AnLF is related to the suspended ML Model Accuracy subscription and then resumes such subscription.

NOTE 4: Steps 8 to 10 in FIG. 5 are the same as Steps 8 to 10 in FIG. 4, therefore the description is provided in the text above.

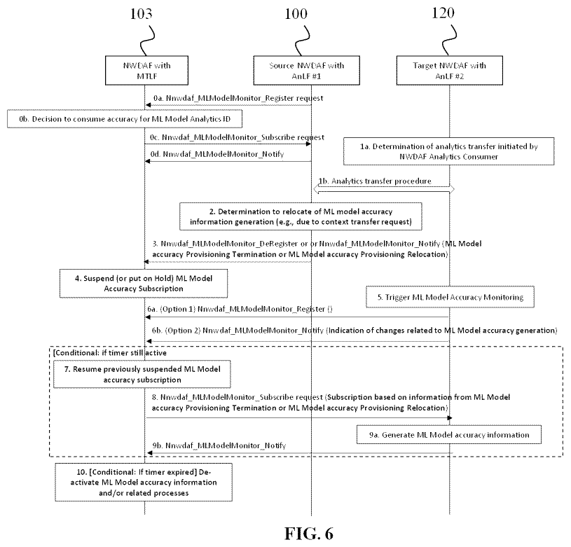

FIG. 6 shows an alternative D: Target triggered analytics transfer procedures with source NWDAF triggered MTLF preparation for ML model accuracy provisioning relocation. This alternative is aimed at preserving the analytics transfer procedures with none or very minor changes and concentrate the changes in order to relocate a ML Model accuracy information monitoring process (also referred as relocation of ML Model accuracy information subscription) in the interactions between source NWDAF with AnLF 100 and NWDAF with MTLF 103. The changes are then concentrated in extensions of Nnwdaf_MLModelMonitor service operations such as Register, Deregister, Subscribe, and Notify. The difference from Alternative A and D, is that the Target NWDAF 102 is the entity starting the analytics transfer.

NOTE 1: Step 0 in FIG. 6 is the same as Step 0 in FIG. 3, therefore the description is provided in the text above.

Step 1. The target NWDAF with AnLF 102 determine that an analytics transfer from a source NWDAF with AnLF 100 should be performed. The target NWDAF with AnLF 102 triggers and executes the analytics transfer, for instance requesting to the source NWDAF with AnLF 100 the analytics context information.

NOTE 2: All the next steps that follow in FIG. 6 are the same steps as in FIG. 3, where Steps 2, 3, and 4 in FIG. 6 are respectively the same as Steps 1, 2, and 3 in FIG. 3, Steps 5 to 10 in FIG. 6 are the same steps 5-10 in FIG. 3.

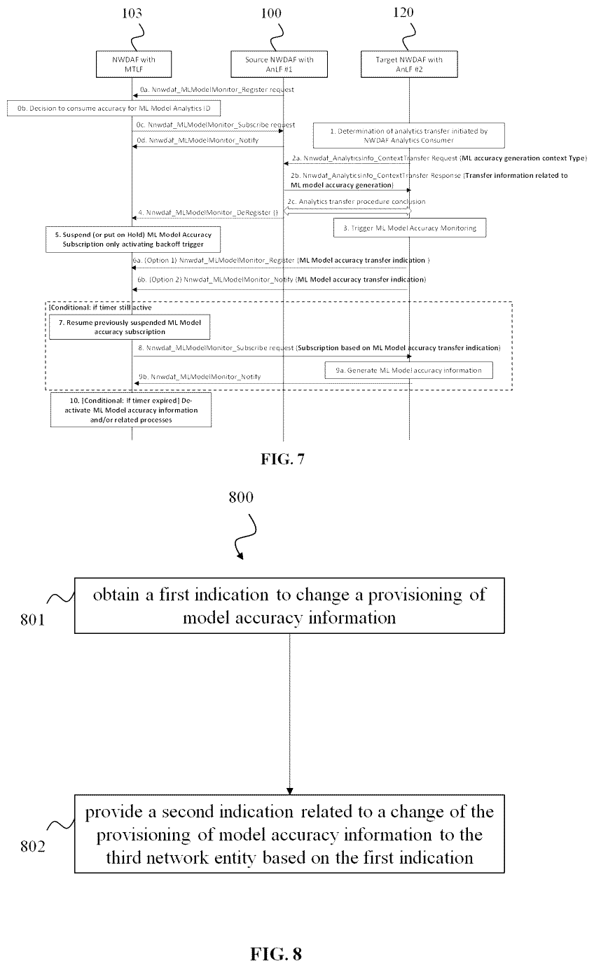

FIG. 7 shows an alternative E: Target triggered analytics transfer procedures with target NWDAF triggered MTLF preparation for ML model accuracy provisioning relocation. This alternative is aimed at concentrating at the Target NWDAF with AnLF the responsibility to relocating a ML Model accuracy information monitoring process (also referred as relocation of ML Model accuracy information subscription). In this case, there are changes in the analytics transfer procedures and in the interactions between target NWDAF with AnLF 102 and NWDAF with MTLF 103. The difference from Alternative C and E, is that the Target NWDAF 102 is the entity starting the analytics transfer.

NOTE 1: Steps 0, 2 to 10 in FIG. 7 are the same as Steps 0, 2 to 10 in FIG. 3, therefore the description is provided in the text above.

FIG. 8 shows a method of this disclosure for generating model accuracy information 105 for a model associated with a model ID and/or an analytics ID. The method 800 is performed by a first network entity 100 (e.g., source NWDAF with AnLF). The method 800 comprises a step 801 of obtaining a first indication 101 to change a provisioning of model accuracy information 105. The provisioning of model accuracy information 105 is consumed by a third network entity 103 for consuming model accuracy information 105 (e.g., NWDAF with MTLF) and is associated with the model and one or more parameter information, and wherein the model accuracy information 105 denotes a quality information about the model. The method 800 further comprises a step 802 of providing a second indication 104 related to a change of the provisioning of model accuracy information 105 to the third network entity 103 based on the first indication 101. The second indication 104 comprises at least one of the following:
A first information indicating a termination of the provisioning of model accuracy information 105 for the model and/or the analytics ID at the first network entity 100.
A second information indicating a relocation of the provisioning of model accuracy information 105 for the model and/or analytics ID from the first network entity 100 to a second network entity 102 (e.g., source NWDAF with AnLF).
A third information indicating one or more changes related to the provisioning of model accuracy information 105 for the model and/or analytics ID.
A fourth information indicating a registration of the second network entity 102 as a provider of model accuracy information 105 for the model and/or analytics ID in accordance with the first indication 101.

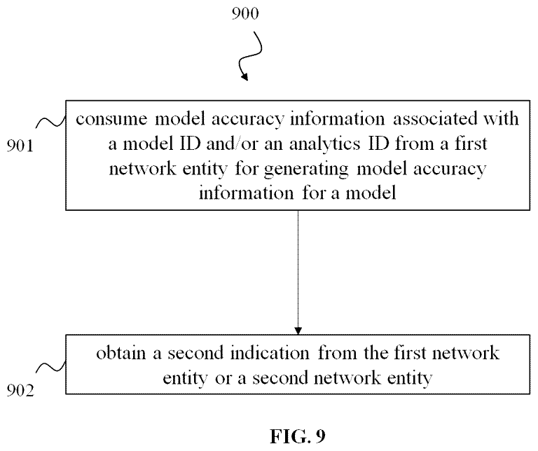

FIG. 9 shows a method 900 of this disclosure for consuming model accuracy information 105 for a model associated with a model ID and/or analytics ID, wherein the model accuracy information 105 denotes a quality information about the model. The method 900 is performed by a third network entity 103 (e.g., NWDAF with MTLF) and comprises a step 901 of consuming model accuracy information 105 associated with the model and/or an analytics ID from a first network entity 100 (e.g., source NWDAF with AnLF) for generating model accuracy information 105 for a model associated with the analytics ID. The method 900 further comprises a step 902 of obtaining the second indication 104 from the first network entity 100 or from a second network entity 102 (e.g., target NWDAF with AnLF), wherein the second indication 104 is as shown above for the method 800.

In summary, this disclosure provides several advantages. For example, it allows reducing the risk of NWDAF with MTLF 103 to determine imprecise quality/correctness about the ML Model for an analytics ID, when NWDAFs using the ML Model may be involved in analytics transfer procedures and MTLF lost the overview of which NWDAFs with AnLF are using the same ML model. This is achieved by indicating the need for changing (or relocating) a subscription for ML Model accuracy information.

Further, the NWDAF with MTLF 103 is able to suspend subscription for ML Model Accuracy Information based on based on configurations and/or the obtained indications from NWDAF with AnLF 100, 102.

Further, the NWDAF with MTLF 103 is able to resume the previously suspended subscription to ML Model accuracy information based on a new registration and/or a notification from a new (Target) NWDAF with AnLF 102 with or without Indication of changes related to ML Model accuracy generation.

A risk of creating situations leading to configuration failures is moreover reduced, wherein only part of all NWDAFs originally using the same ML Model for an analytics ID are updated with the new (hopefully better) ML model for the analytics ID. This may be achieved by the NWAF with MTLF 103 providing a request for a subscription for ML Model accuracy monitoring to a further NWDAF with AnLF based on the ML Model Accuracy Provisioning Termination or ML Model Accuracy Provisioning Relocation or ML Model accuracy transfer indication.

The present disclosure has been described in conjunction with various embodiments as examples as well as implementations. However, other variations can be understood and effected by those persons skilled in the art, from the studies of the drawings, this disclosure and the claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A first network entity for generating model accuracy information for a model associated with a model identifier (ID) and/or an analytics ID, the first network entity comprising:
a memory having processor-executable instructions stored thereon; and
a processor configured to execute the processor-executable instructions to facilitate the following being performed by the first network entity:
obtaining a first indication to change a provisioning of model accuracy information for the model, wherein the provisioning of model accuracy information for the model is consumed by a third network entity, wherein the provisioning of model accuracy information for the model is associated with parameter information, and wherein the model accuracy information denotes quality information about the model; and
providing a second indication related to the change of the provisioning of model accuracy information for the model to the third network entity based on the first indication, wherein the second indication comprises at least one of the following:
first information indicating a termination of the provisioning of model accuracy information for the model and/or the analytics ID at the first network entity;
second information indicating a relocation of the provisioning of model accuracy information for the model and/or the analytics ID from the first network entity to a second network entity;
third information indicating one or more changes related to the provisioning of model accuracy information for the model and/or the analytics ID; or
fourth information indicating a registration of the second network entity as a provider of model accuracy information for the model and/or the analytics ID in accordance with the first indication.

2. The first network entity according to claim 1, wherein the processor is further configured to execute the processor-executable instructions to facilitate the following being performed by the first network entity:
obtaining the first indication to change the provisioning of model accuracy information for the model based on least one of the following:
identifying that the model and/or the analytics ID associated with the provisioning of model accuracy information is related to an analytics transfer from the first network entity to the second network entity; or
receiving from the second network entity any of the following:
a model accuracy information context type, which indicates that transfer information related to the provisioning of model accuracy information is to be included into analytics context information;
a model accuracy information context flag, which indicates that the model accuracy information context type is to be requested; or
one or more parameters related to the provisioning of model accuracy information for the model.

3. The first network entity according to claim 2, wherein the processor is further configured to execute the processor-executable instructions to facilitate the following being performed by the first network entity:
requesting the one or more parameters from the second network entity based on the first indication being obtained by receiving the model accuracy information context type or the model accuracy information context flag from the second network entity.

4. The first network entity according to claim 1, wherein the processor is further configured to execute the processor-executable instructions to facilitate the following being performed by the first network entity:
providing the second indication to the third network entity included in a de-registration message or in a notification message.

5. The first network entity according to claim 1, wherein the second indication further comprises at least one of the following:
a registration ID of the first network entity, which is related to the provisioning of model accuracy information for the model by the first network entity; or
a subscription ID of the third network entity at the first network entity, for the provisioning of model accuracy information for the model by the first network entity.

6. The first network entity according to claim 1, wherein the fourth information comprises an ID of the second network entity, and wherein the second network entity is registered as a provider of model accuracy information for the model and/or the analytics ID.

7. A third network entity for consuming model accuracy information for a model associated with a model identifier (ID) and/or an analytics ID, wherein the model accuracy information denotes quality information about the model, wherein the third network entity comprises:
a memory having processor-executable instructions stored thereon; and
a processor configured to execute the processor-executable instructions to facilitate the following being performed by the third network entity:
consuming model accuracy information for the model and/or the analytics ID, from a first network entity for generating the model accuracy information for the model and/or the analytics ID; and
obtaining a second indication from the first network entity or a second network entity, wherein the second indication comprises at least one of the following:
first information indicating a termination of a provisioning of model accuracy information for the model and/or the analytics ID at the first network entity;
second information indicating a relocation of the provisioning of model accuracy information for the model and/or the analytics ID from the first network entity to the second network entity;
third information indicating one or more changes related to the provisioning of model accuracy information for the model and/or the analytics ID from the second network entity; or
fourth information indicating a registration of the second network entity as a provider of model accuracy information for the model and/or the analytics ID.

8. The third network entity according to claim 7, wherein the processor is further configured to execute the processor-executable instructions to facilitate the following being performed by the third network entity:
determining a relationship and/or mapping between the obtained second indication and the consumption of model accuracy information for the model and/or the analytics ID by the third network entity;
wherein the consumption of model accuracy information for the model is associated with parameter information.

9. The third network entity according to claim 7, wherein the processor is further configured to execute the processor-executable instructions to facilitate the following being performed by the third network entity:
suspending usage of data and/or one or more processes related to consumption of model accuracy information from the first network entity based on a local configuration and/or based on the second indication comprising the first information or the second information.

10. The third network entity according to claim 9, wherein suspending the one or more processes related to consumption of model accuracy information comprises:
a) stopping the changing or deleting, for a determined period of time, of any of the following:
data associated with the consumption of model accuracy information from the first network entity; or
a training or retraining process related to the model associated with the consumption of model accuracy information from the first network entity; or
b) pausing the consumption of model accuracy information for a determined period of time, without changing or deleting at least one of the following:
a subscription for the consumption of model accuracy information from the first network entity;
data associated with the consumption of model accuracy information from the first network entity; or
a process related to the consumption of model accuracy information from the first network entity.

11. The third network entity according to claim 7, wherein the processor is further configured to execute the processor-executable instructions to facilitate the following being performed by the third network entity:
providing a request for a new provisioning of model accuracy information to the second network entity, wherein the request is based on the second indication comprising the fourth information.

12. The third network entity according to claim 11, wherein the processor is further configured to execute the processor-executable instructions to facilitate the following being performed by the third network entity:
reusing or relocating or re-associating data and/or information from the one or more processes associated with the consumption of model accuracy information from the first network entity to the new provisioning of model accuracy information for the model and/or the analytics ID from the second network entity.

13. The third network entity according to claim 7, wherein the processor is further configured to execute the processor-executable instructions to facilitate the following being performed by the third network entity:
updating information at the third network entity, which is related to the consumption of model accuracy information for the model and/or the analytics ID from the second network entity, based on the second indication comprising the third information.

14. The third network entity according to claim 13, wherein the processor is further configured to execute the processor-executable instructions to facilitate the following being performed by the third network entity:
reusing or relocating or re-associating data and/or information from the one or more processes associated with the consumption of model accuracy information from the first network entity to the updated information related to the consumption of model accuracy information for the model and/or the analytics ID from the second network entity.

15. The third network entity according to claim 9, wherein the processor is further configured to execute the processor-executable instructions to facilitate the following being performed by the third network entity:
resuming the usage of the data and/or one or more processes related to the consumption of model accuracy information based on the second indication.

16. The third network entity according to claim 9, wherein the processor is further configured to execute the processor-executable instructions to facilitate the following being performed by the third network entity:
determining that the second network entity is related to the suspended data and/or one or more processes related to the consumption of model accuracy information for the model and/or analytics ID provided by the first network entity, and to resume the usage of data and/or one or more processes related to consumption of model accuracy information from the first network entity.

17. The third network entity according to claim 15, wherein resuming the data and/or one or more processes related to the consumption of model accuracy information comprises:
reusing or relocating or re-associating data and/or information from the suspended one or more processes to a new provisioning of model accuracy information for the model and/or the analytics ID from the second network entity.

18. The third network entity according to claim 10, wherein the processor is further configured to execute the processor-executable instructions to facilitate the following being performed by the third network entity:
based on a time period associated with the suspended one or more processes expiring before the third network entity receives the third or fourth information from the second network entity, de-activating the suspended one or more processes and/or deleting data related to the suspended one or more processes.

19. A method for generating model accuracy information for a model associated with a model identifier (ID) and/or an analytics ID, wherein the method comprises:
obtaining, by a first network entity, a first indication to change a provisioning of model accuracy information for the model, wherein the provisioning of model accuracy information for the model is consumed by a third network entity for training models, wherein the provisioning of model accuracy information for the model is associated with parameter information, and wherein the model accuracy information denotes quality information about the model; and
providing, by the first network entity, a second indication related to a change of the provisioning of model accuracy information to the third network entity based on the first indication, wherein the second indication comprises at least one of the following:
first information indicating a termination of the provisioning of model accuracy information for the model and/or the analytics ID at the first network entity;
second information indicating a relocation of the provisioning of model accuracy information for the model and/or the analytics ID from the first network entity to a second network entity;
third information indicating one or more changes related to the provisioning of model accuracy information for the model and/or the analytics ID; or
fourth information indicating a registration of the second network entity as a provider of model accuracy information for the model and/or the analytics ID in accordance with the first indication.

20. The method according to claim 19, further comprising:
obtaining the first indication to change the provisioning of model accuracy information based on least one of the following:
by identifying that the model and/or the analytics ID associated with the provisioning of model accuracy information is related to an analytics transfer from the first network entity to the second network entity; or
by receiving from the second network entity any of the following:
a model accuracy information context type, which indicates that transfer information related to the provisioning of model accuracy information is to be included into analytics context information;
a model accuracy information context flag, which indicates that the model accuracy information context type is to be requested; or
one or more parameters related to the provisioning of model accuracy information for the model.
